(19) United States
(12) Patent Application Publication
(10) Pub. No.: US 2008/0262141 A1
(43) Pub. Date: Oct. 23, 2008

(54) Dye Materials and Infra Red Active Polymer Compositions Thereof

(76) Inventor: Ferenc Cser, New South Wales (AU)

Correspondence Address: WOOD, HERRON & EVANS, LLP, 2700 CAREW TOWER, 441 VINE STREET, CINCINNATI, OH, 45202, US

(21) Appl. No.: 11/574,623

(22) PCT Filed: Sep. 1, 2005
(86) PCT No.: PCT/AU2005/001331

§ 371 Date: Aug. 30, 2007

(30) Foreign Application Priority Data
Sep. 3, 2004 (AU) 2004905014

(51) Int. Cl. C09B 67/08

(52) U.S. Cl. 524/447; 524/445

(57) ABSTRACT

Nanopigments were prepared from organic IR dye and Na-bentonite with CEC of 95 mmole Na per 100 g of bentonite, at room temperature, by dissolving the Na-bentonite in water and mixing for 2 hours, and mixing in the dye, dissolved in ethanol, for 18 hours. The precipitate is filtered, washed three times with water/ethanol mixture, dried at 105° C. for 10 hours, and milled in a kitchen miller for 2 mins. 0.3 parts of the nanopigments were mixed to 100 parts of pulverized SPG resin and processed in an extruder with a die temperature of 190° C. to form transparent, faintly green or grey coloured extrudates which were used to press film of 0.4 mm thickness at 160° C. The films were used to prepare IR-active laminated glass. Near infrared absorption spectra of the glass structures were obtained in a Perkin-Elmer Spectrophotometer.

### FIELD OF THE INVENTION

This invention relates to dye materials and infrared (IR) active polymer compositions thereof.

This invention has particular but not exclusive application to dye materials, and IR active polymer compositions incorporating said dye materials for use in glazing laminates, and for illustrative purposes reference will be made to such application. However, it is to be understood that this invention could be used in other applications, such as providing infrared active coatings.

### PRIOR ART

WO 02/070254 A1 published 12 Sep. 2002 describes IR active glazing laminates to ameliorate heating of the interior of a building by solar radiation. The disclosure includes glazing laminates having IR absorbing dye in polymer to form at least one IR active layer, usually sandwiched between glass layers. Production of the infrared active polymeric layer presents technological difficulties. The solvent casting method used to prepare the active layer on glass surfaces could not be used to prepare active layers with larger homogeneous surface areas due to the extremely high surface tension of the solution of the carrier polymer. Using mixtures of different solvents, for example a mixture of a good solvent with higher volatility and a poor solvent with lower volatility, made it possible to cast the active layer at decimetre area scales but the casting techniques are difficult to use successfully for much bigger surface areas.

The infrared active organic material selected also showed yellow to green colour which may be a commercial disadvantage in certain applications. In order to ameliorate the yellow/green tint, grey organic dyes were added, reducing the net visible transmission. As the organic colour dyes tended to react with the IR and other dyes, this necessitated the use of discrete dye layers increasing laminate complexity.

The infrared active organic materials are not readily mixed into the melt of thermoplastic polymers used for the lamination by conventional polymer processing techniques. The thermoplastic polymer systems do not effectively dissolve the infrared active organic material under processing conditions, resulting in the dyes acting instead as poor pigments of particle sizes above the micrometer range, and the films produced in this way were accordingly ineffective and non transparent.

The infrared active organic materials are generally not readily dissolved in curable liquid resin systems such as unsaturated polyester or epoxy resins. It has been observed that the infrared activity of attempts at such compositions reduced to essentially zero during the cure, presumably as a side reaction to the sure, such that the cured cross-linked resin compositions did not exhibit useful infrared activity.

There accordingly remains a need for dye materials that may be used in the production of IR active polymer compositions that can be produced by conventional polymer technologies like batch mixing, extrusion or film blowing or cross-linking of liquid polymeric resins. It is an object of preferred embodiments of the present invention to provide IR active polymer compositions that are useful for the production of laminated IR active glazing materials. It is a further object of particular embodiments of the present invention to provide an IR active polymer composition which incorporates the dye materials that provides a colour matched film at the same technical step of production as forming the film melt.

### DESCRIPTION OF THE INVENTION

In one aspect the present invention resides broadly in a dye composition including an organic dye nano-encapsulated in a clay material.

The organic dye may be selected from one or more dyes known for their IR active properties. However, it is envisaged that other dye materials may undergo a shift in the absorption maximum Aₘₐₓ as a consequence of nano-encapsulation and/or dispersal of the dye composition in a polymer matrix to form polymer compositions that absorb IR radiation. Alternatively the dye may be selected to provide for polymer compositions that absorb in other parts of the EM spectrum such as the UV or visible bands.

For example, some of the common organic dyes used to colour textile, wood, leather etc. may also be encapsulated. Indigo, Rhodamine B, Saframine and many other colouring dyes may be reacted with layered silicate clay materials to form nanopigment with retention of the colour of the dye with slight modification. These nanopigments can also be mixed with different polymers including those used to prepare laminated glazing. These nanopigments can be used to match the colour of the infrared active nanopigment modified polymer to form for example grey coloured laminates. The nanopigments are compatible, they do not react with each other, and therefore they can be mixed to the same polymeric layer.

The clay may be selected from the layered clay materials known to form nano-encapsulates. For example the clay material may be selected from smectic clays such as bentonite or montmorillonite or other natural or synthetic laminar clay material. Preferably the clay material has a cation exchange capacity (CEC) of 60-180 mmole sodium equivalent/100 g of clay. It has been observed that not all ostensibly infrared active organic materials, nano-encapsulated in layered clay materials to form a “nanopigment”, that is a nanoparticulate composition exhibiting dye-like properties, keep their infrared activity in polymer composition. However, a surprising result is that all of the materials tested could be mixed with glazing or optical curable and thermoplastic polymeric systems to form transparent polymeric films and laminates.

The nanopigments of the present invention may be produced by any suitable process. For example, the infrared active organic materials such as immonium type dyes typified by the EPOLIGHT infrared dyes of the 1000 and 2000 series such as the 1125, 1178 and 2057 types may be nano-encapsulated with a clay material such as Na-bentonite with a CEC of 95 mmole Na per 100 g of bentonite at room temperature by dissolving the Na-bentonite in water and mixing thoroughly, then adding the dye preferably dissolved in a solvent miscible in water such as a lower alcohol. The nano-encapsulation reaction may be conducted in the water/alcohol mixture at ambient temperatures, or may be conducted at temperatures of typically between 20° C. to 80° C. for reaction times of from 4 hours to 24 hours to form infrared active nanopigment. The precipitate may be filtered, washed with water/alcohol mixture (preferably until the eluate substantially ion-free), and dried before milling.

The ratio of dye to clay depends on the chemical nature of the dye and may for example vary from 0.05 to 0.3 parts of dye per part of clay. The filtered precipitate formed in the reaction is preferably washed with water/alcohol mixture until the effluent is ion free. After drying, preferably at room temperature either in vacuum or at atmospheric pressure, the precipitate is preferably milled to average particle size of less than 15 μm to obtain the infrared active nanopigment.

It is observed that mere mechanical mixtures of the clay and dye without the reaction in an aqueous environment produced compositions that when incorporated in polymer produced films that were non transparent and did not show appreciable infrared activity.

The reaction of the dye with clay may be demonstrated by comparing the X-ray diffraction patterns of dye compositions produced in accordance with the present invention with the diffraction patterns of the mere mechanical mixtures, indicating that, in the reacted product, swelling in the clay materials indicates the intercalation of the organic dye.

Accordingly, in a further aspect this invention resides broadly in a method of producing a nano-encapsulated dye material including the steps of:

dispersing a clay material having a cation exchange capacity (CEC) of 60-180 mmole sodium equivalent/100 g of clay in an aqueous medium;

dissolving an organic dye in a solvent or mixture which is miscible with said aqueous medium;

mixing said dispersed clay and dissolved dye to form a precipitate;

separating said precipitate;

drying said precipitate; and

milling said dry precipitate to an average particle size of less than 15 μm.

Preferably, there is a step after separating the precipitate of washing until the eluate is essentially ion free, in order to avoid any unintended reaction of free ions with resin systems. The particle size of the milled composition appears to have a correlation with UV stability of the composition. As the particle size decreases, the UV stability also tends to decrease with some dye/clay compositions. Accordingly it is preferred that the particle size be empirically selected to be less than 15 μm to avoid haze while maintaining a sufficient particle size to maximize UV stability.

In another aspect this invention resides broadly in a dye composition including an organic dye nanoencapsulated in a clay material having a cation exchange capacity (CEC) of 60-180 mmole sodium equivalent/100 g of clay.

The dye compositions of the present invention may be utilized in thermoplastic polymer compositions by incorporation in the particulate polymer before melt forming or directly into the polymer melt. It has been determined that the temperature stability of organic dyes is enhanced by nano-encapsulation in the clay materials. The dye compositions may be incorporated into curable liquid polymer compositions by dispersal in the liquid prepolymer before curing. It is observed that organic dyes that would otherwise react with the curing system are rendered substantially inert to the curing system on nano-encapsulation according to the present invention.

Accordingly, in a further aspect this invention resides broadly in an optically active polymer composition including an optically transmissive polymer matrix having dispersed therein a dye composition including an organic dye nano-encapsulated in a clay material.

The polymer compositions may be used in many applications. For example, liquid curable polymer compositions may be used as an encapsulating or potting composition for optically active electronic components such as light emitting or sensing devices. In one application the liquid curable composition may form an integral IR filter layer for a light sensing element used to switch electronic circuits controlling, for example, security or safety lighting.

Laminated glass structures for preventing the penetration of heating solar radiation generally have at least one polymer layer between at least outer glass layers. The polymer layer may contain the present nano-encapsulated dye materials selected to have a high optical density in the required infrared energy range. Thermoplastic polymer containing the infrared active nanopigment may be prepared either by using conventional thermoplastic polymer processing techniques like extrusion or film blowing, hot formed to the glass surfaces or adhered with an adhesive interlayer. Curable liquid polymer compositions containing the nano-encapsulated dye may be cast as a curable liquid straight to the glass surfaces, whereby the curing process both adheres the laminate and cross-links the polymer to the solid state. Alternatively, the curable polymer may be formed into optically active sheets to be adhesively laminated to the glass layers.

The infrared active nanopigment may be mixed into thermoplastic polymers used for the preparation of security glass, such as polyvinyl butyral (PVB) or poly (ethylene-co-acrylic acid) or other polymers or polymeric systems used for similar purposes. The incorporation may be by conventional thermoplastic processing techniques like batch mixing or extrusion to prepare either master batch or directly a polymeric film. Film can either be extruded or blown from the polymer containing the suitable amount of infrared active nanopigment. The film used for preparing laminated glazing with heat retarding effect may contains from about 0.1 to about 0.5 parts of infrared active nanopigment per 100 parts of carrier polymer. Master batches contain up to 10 parts of infrared active nanopigments per 100 parts of carrier polymer may be used to aid dispersion in the final polymer composition.

The infrared active nanopigment may be mixed into liquid polymeric systems such as unsaturated polyester, epoxy or urethane polymeric systems to about 0.1 to about 0.5 parts of infrared active nanopigment(s) per 100 parts of liquid polymeric system.

The laminated glass structure with the polymeric layer containing the infrared active nanopigment or pigments absorbs IR radiation having an incident direction and spherically re-radiates the absorbed energy. Due to the difference in refractive index of the layers a proportion of the energy in conducted by total internal reflection to the laminate edges to be guided out of the structure. The re-radiated light can either be redirected to the outer space using reflective surface or be absorbed by suitable device and utilized for other purposes, such as is described in WO 02/070254 A1.

### BRIEF DESCRIPTION OF THE FIGURES

In order that this invention may be more readily understood and put into practical effect, reference will now be made to the following examples and accompanying Figures which describe a preferred embodiment of the invention and wherein:

FIG. 1 is a plot of the energy dispersion of solar radiation;

FIG. 2 is a detail shows the NIR absorption of structures in accordance with the present invention;

FIG. 3 is a comparative the X-ray diffraction pattern distinguishing dye materials in accordance with the present invention from mere admixtures of the components; and

FIG. 4 is a plot of the infrared activity of the nanopigment compared to that of mere admixtures of the components.

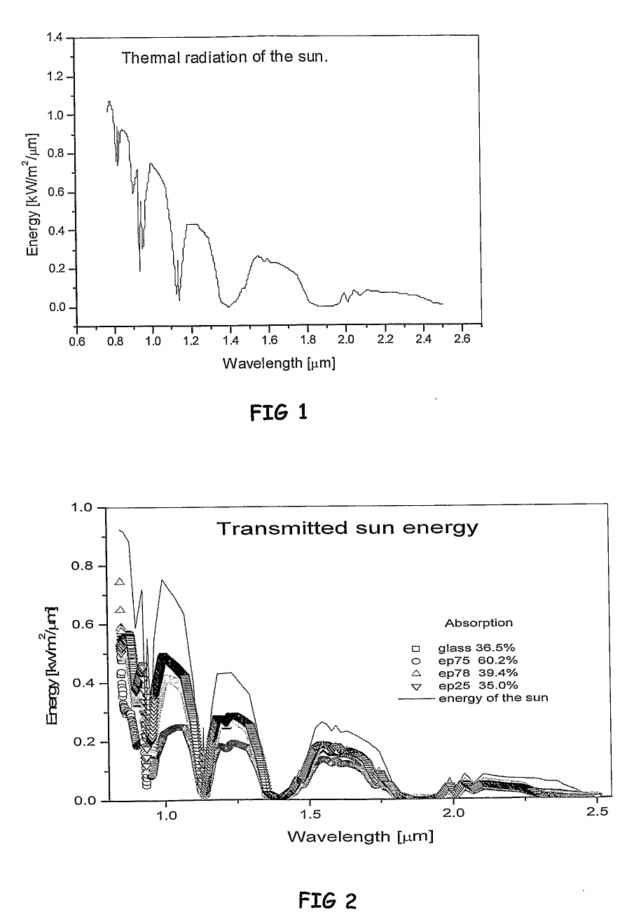

### DESCRIPTION OF THE EMBODIMENTS AND COMPARATIVE EXAMPLES

### Example 1

A glass structure was constructed from two glass microscopy slides of 1 mm thickness, and laminated by a 0.4 mm thick polymeric layer, which contained 0.3 parts of nanopigment. The nanopigment was formed by the process of the present invention from 1 parts of EPOLIGHT 2057 Near-IR dye and 9 parts of Na-bentonite with a CEC of 92 mmole Na per 100 g of clay. The structure was illuminated by a laser diode source with a maximum of 30 μA photo current and having a wavelength of 930 nm. The re-directed IR energy was measured at the edge of the structure, where a 1 μA photo current could be measured.

The IR retardation power of the structure depends on the type and on the specific amount of the dye given as g/m2. 65% retardation can be achieved by 0.1-0.3 g/m2 amount of dye keeping 65-85% of optical transparency. Using 0.7-1.2 g/m2 dye concentration 90-98% retardation can be achieved with 55-65% of optical transparency. These data are achieved using EPOLIGHT 2057 within SGP resin of poly(ethylene-co-acrylic acid).

At least 135° C. annealing temperature is necessary to form laminated glazing from the polymer containing the nanopigment and the dye survives at this temperature in SGP layer for 30-35 min. The nanopigment did not lose its retardation effect when mixed into unsaturated polyester resin and polymerized at room temperature using peroxide initiator.

### Example 2

Nanopigments were prepared from 1 part by weight of infrared active organic materials (EPOLITE infrared dyes of 1125, 1178 and 2057 types) and 10 parts by weight of Na-bentonite with CEC of 95 mmole Na per 100 g of bentonite, at room temperature, by dissolving the Na-bentonite in 100 parts by weight of water and mixing for 2 hours. The dye is dissolved in 5 parts by weight of ethanol and mixed into the aqueous solution for 18 hours. Colourless solution is seen above discoloured precipitate. The sediment is filtered, washed three times with 10 parts of 1:1 water/ethanol mixture. The precipitate is then dried at 105° C. for 10 hours at atmospheric pressure. The dried material is milled in a kitchen miller for 2 mins.

0.3 parts of the respective nanopigments of Example 2 are mixed to 100 parts of pulverized SPG resin. The mixture is fed into an extruder with a die temperature of 190° C. using 50 RPM and a residence time of 4 mins. Transparent, faintly green or grey coloured extrudates were obtained. The extrudates were used to press film of 0.4 mm thickness at 160° C. in a conventional press. The films were used to prepare laminated glass using 2 glass plates of 1 mm thickness at 135° C. with 3 pps pressure applied for 20 mins. Near infrared absorption spectra of the glass structures were obtained in a Perkin-Elmer Spectrophotometer. FIG. 2 shows the NIR absorption of some of the structures with different absorptive power as well as the energy dispersion of the IR retardation.

When the same structures were prepared from the mechanical mixture of the infrared active organic material and Na-Bentonite with the same compositions used to prepare nanopigment without the chemical reaction carried out in watery environment, the films were non transparent and did not show infrared activity at all.

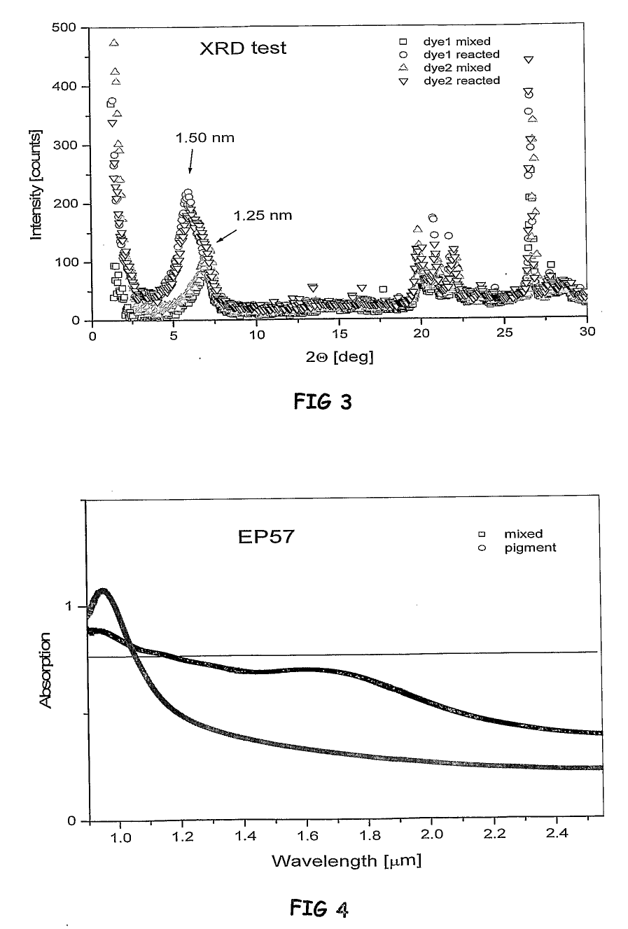

The reaction of the infrared organic materials with Na-Bentonite is proven by X-ray diffraction patterns shown in FIG. 3. Here the X-ray diffraction pattern of the mechanical mixture is compared to those of the reacted product indicating a swelling in the clay materials as an indication of the intercalation of the organic dye.

The infrared activity of the nanopigment is compared to that of the mechanical mixture with the same composition on FIG. 4. The mechanical mixture does not show remarkable infrared activity at the highest energy range of the heating radiation of the Sun. The nanopigment shows an intensive absorption peak there (wavelength of 1 μm). Here the data of EPOLIGHT 2057 are shown. This is another proof of the chemical reaction of the infrared active organic material with the laminar clay mineral.

### Example 3

0.8 parts of Rhodamine B is mixed with 10 parts of water then 0.01 parts of 1 mole/litre hydrochloric acid are added to the solution. 10 parts of Na-bentonite is mixed with 100 parts of water and the two solutions are mixed and stirred for 4 hours. The pink solution turns colourless and pink material is precipitated. The precipitate is washed three times with de-ionized water, dried and milled. 1 parts of this nanopigment is mixed to 15 parts of infrared active nanopigment formed from Epoline 2057 to match its colour in SGP resin shown above.

### Example 4

30 g of BECKEPOX EP824 is mixed with 0.3 g of pigment prepared from Na-bentonite 1 g and EPOLIGHT 2057 0.15 g in a Silverson mixer for 45 min. The dark green mixture is degassed and mixed with 13.9 g of BECKEPOX EH624. 1 mm layer of the mixture is formed between two glass plates of 1 mm thick each. The laminate is solid in 1 hour. It is post cured at 90° C. for 1 hour. The IR retardation of the laminate is 73%, visual transparency is 55%. The laminate has a green-grey colour.

The same mixture is prepared using 0.045 g of Epolight 2057 instead of 0.3 g of pigment. The initially dark green solution is colourless within 5 min and the laminate formed from the mixture and two glass plates has an IR retardation of 21%.

### Example 5

50 g of GLASSLAM resin is mixed with 0.3 g of pigment formed from 1 g of Na-Bentonite and 0.15 g of EPOLITE 2067 in a Silverson mixer for 1 hour. The dark green transparent solution is mixed with 0.05 g of methyl-ethyl ketone peroxide and 1 mm of layer of the well mixed solution is formed between two glass plates of 1 mm thick. The laminate is solid in 1 hour, and it is post cured at 60° C. for 1 hour. The IR retardation of the laminate is 78%; its visual transparency is 60%. The laminate has a blue-green grey colour.

If the same mixture is prepared using 0.05 g of EPOLIGHT 2067 instead of the pigment, the originally dark green colour of the mixture is lost within 3 min after methyl-ethyl ketone peroxide was mixed. The laminate did not cure properly; it remained soft even after post curing for 3 h at 90° C. The IR retardancy of the laminate is 19%.

### Example 6

125 g of dihexyl sebacate is mixed with 6 g of pigment prepared from Na-bentonite 1 g and EPOLIGHT 2057 0.15 g and mixed in a Silverson mixer for 6 hours. The dark green liquid is mixed with 375 g of polyvinyl butyral (PVB) powder produced by Chang Chun Petrochemical Co. Taiwan and fed into the feeder of a twin screw extruder with a 175° C. barrel and dye temperature. The extrudate produced by 90 RPM is pelletised. 1 mm thick sheets of brownish green colour are pressed from the pellets at 145° C. Part of the sheet is inserted in between two glass plates and heated at 135° C. for 10 min in an oven using a pressing frame. The IR retardancy of the laminate is 69%

When 1 g of Epolight 2057 is used instead of the pigment, the sheets contain individual dye particles, its colour is light brownish yellow and its IR retardancy is 22%.

### Example 7

500 g of Sentry Glass Polymer (Dupont) pellet is mixed with 6 g of pigment prepared from Na-bentonite 1 g and EPOLIGHT 2057 0.15 g and fed into the feeder of a twin screw extruder with 190° C. of barrel and 180° C. of dye temperatures. The extrudate produced by 90 RPM is pelletised, and 1 mm thick layers of greenish grey colour are pressed from the pellet at 160° C. Part of the sheet is inserted in between two glass plates and heated at 145° C. for 10 minutes in an oven using a pressing frame. The IR retardancy of the laminate is 59%

When 1 g of Epolight 2057 is used instead of the pigment, the sheets contain individual dye particles, its colour is light brownish yellow and its IR retardancy is 20%.

Remarks: IR retardancy was measured by IR spectrophotometer and the retarded energy was calculated by integration of the transmitted energy of the Sun. This means that the energy spectrum of the Sun was multiplied by the transparency values measured by the spectrophotometer. Generally IR retardancy is given in the literature as the peak absorption level of the IR spectrum. In these examples the peak absorption levels at 1000 nm were 85%-19%, 84%-21%, 95%-30%, and 90%-27% respectively.

This process does not need solvent casting. It is environmental friendly. The encapsulation of the infrared active organic material protects the activity against environmental hazards like UV radiation, chemicals in the resins. The long term stability of the system is increased. The solvent(s) used for preparing the nanopigment is(are) to be reused and easily to be recycled. The encapsulation can be carried out as the final cleaning process in the preparation of the infrared active organic materials therefore there is no need to use dangerous chemicals there like antimon-hexafluoric acid or other strong acids.

It will of course be realised that while the above has been given by way of illustrative example of this invention, all such and other modifications and variations thereto as would be apparent to persons skilled in the art are deemed to fall within the broad scope and ambit of this invention as is herein set forth.

1. A dye composition including an organic dye nano-encapsulated in a clay material.

2. The dye composition according to claim 1, wherein said organic dye is selected from one or more IR active dyes.

3. The dye composition according to claim 1, wherein said organic dye is selected from dye materials that undergo a shift in the absorption maximum Aₘₐₓ as a consequence of nano-encapsulation and/or dispersal of the dye composition in a polymer matrix to form polymer compositions that absorb IR radiation.

4. The dye composition according to claim 1, wherein said organic dye is selected to provide for polymer compositions that absorb in other parts of the EM spectrum such as the UV or visible bands.

5. The dye composition according to claim 1, wherein said clay is selected from smectic clays and other natural or synthetic laminar clay materials.

6. The dye composition according to claim 5, wherein said clay is selected from bentonite or montmorillonite.

7. The dye composition according to claim 5, wherein said clay material has a cation exchange capacity (CEC) of 60-180 mmole sodium equivalent/100 g of clay.

8. The dye composition according to claim 7, wherein the ratio of dye to clay is from 0.05 to 0.3 parts of dye per part of clay.

9. The dye composition according to claim 7, wherein the composition is milled to average particle size of less than 15 μm.

10. A method of producing a nano-encapsulated dye material including the steps of:
(a) dispersing a clay material having a cation exchange capacity (CEC) of 60-180 mmole sodium equivalent/100 g of clay in an aqueous medium;
(b) dissolving an organic dye in a solvent or mixture which is miscible with said aqueous medium;
(c) mixing said dispersed clay and dissolved dye to form a precipitate; separating said precipitate;
(d) drying said precipitate; and
(e) milling said dry precipitate to an average particle size of less than 15 μm.

11. The method according to claim 10, wherein there is included between steps (c) and (d) a further step of washing said precipitate until the washing eluate is essentially ion free.

12. The method according to claim 10, wherein said dye selected from one or more immonium type IR active dyes.

13. The method according to claim 12, wherein said solvent includes a lower alcohol.

14. The method according to claim 10, wherein said clay material is Na-bentonite with a CEC of 95 mmole Na per 100 g of bentonite at room temperature.

15. The method according to claim 10, wherein said nano-encapsulation reaction is conducted at between 20° C. to 80° C. for reaction times of from 4 hours to 24 hours.

16. The method according to claim 10, wherein the ratio of dye to clay is from 0.05 to 0.3 parts of dye per part of clay.

17. A dye composition prepared according to the method of claim 10.

18. A dye composition including an organic dye nanoencapsulated in a clay material having a cation exchange capacity (CEC) of 60-180 mmole sodium equivalent/100 g of clay.

19. The dye composition according to claim 1, when used in thermoplastic polymer compositions by incorporation in the particulate polymer before melt forming or directly into the polymer melt.

20. The dye composition according to claim 1, when incorporated into curable liquid polymer compositions by dispersal in the liquid prepolymer before curing.

21. An optically active polymer composition including an optically transmissive polymer matrix having dispersed therein a dye composition including an organic dye nano-encapsulated in a clay material.

22. The polymer composition according to claim 21, wherein said dye composition includes a nano-encapsulated dye material produced by a method including the steps of:
(a) dispersing a clay material having a cation exchange capacity (CEC) of 60-180 mmole sodium equivalent/100 g of clay in an aqueous medium;
(b) dissolving an organic dye in a solvent or mixture which is miscible with said aqueous medium;
(c) mixing said dispersed clay and dissolved dye to form a precipitate; separating said precipitate;
(d) drying said precipitate; and
(e) milling said dry precipitate to an average particle size of less than 15 μm.

23. The polymer composition according to claim 22, wherein said method includes between steps (c) and (d) a further step of washing said precipitate until the washing eluate is essentially ion free.

24. The liquid curable polymer composition according to claim 21, when used as an encapsulating or potting composition for optically active electronic components.

25. The polymer composition according to claim 21, when used as a polymer layer in laminated glass structures.

26. The polymer composition according to claim 21, wherein said polymer is selected from polyvinyl butyral (PVB) and poly (ethylene-co-acrylic acid).

27. The polymer composition according to claim 21, wherein the dye content is about 0.1 to about 0.5 parts of infrared active nanopigment per 100 parts of polymer.
